(19) United States
(12) Patent Application Publication
(10) Pub. No.: US 2020/0195360 A1
(43) Pub. Date: Jun. 18, 2020

(54) Video over IP based broadcast productions by combining a Broadcast Controller and a Processing Device

(71) Applicant: EVS Broadcast Equipment SA, Seraing (BE)

(72) Inventors: Sven De Becker, Oplinter (BE); Christophe Messa, Liege (BE); Frédéric Lückers, Searing (BE); Johan Vounckx, Liden (BE)

(73) Assignee: EVS Broadcast Equipment SA, Seraing (BE)

(21) Appl. No.: 16/500,457

(22) PCT Filed: Apr. 5, 2018
(86) PCT No.: PCT/EP2018/058798

§ 371 Date: Oct. 3, 2019

(30) Foreign Application Priority Data
Apr. 5, 2017 (EP) 17165043.5

(51) Int. Cl. H04H 20/10; H04H 20/12; H04L 29/06; H04H 60/32; H04H 60/27

(52) U.S. Cl. CPC H04H 20/103; H04H 20/12; H04H 60/27; H04H 60/32; H04L 65/80

(57) ABSTRACT

Broadcast production system including broadcast production devices and network switches is suggested. The broadcast production devices in the network switches are connected with a network transmitting data streams. A broadcast controller is configured to manage communication between the broadcast devices and a processing device connected to at least one network switch. The processing device is configured to ingest a data stream passing through the at least one network switch. The processing device then applies applications to the input data streams. The resulting output data stream is transmitted over the network under control of the broadcast controller. The broadcast production system provides operational flexibility since it permits different ways of using the ingested data streams for different applications of the processing device. Furthermore, a method for operating the broadcast production system is suggested.

### FIELD

The present disclosure relates to a method and a system for monitoring and processing signal streams in an IP network based broadcast production.

### BACKGROUND

In an IP network based broadcast production, all communication happens over IP networks. This kind of production is also known as “Distributed Video Production” and described for example in the article “Distributed Video Production: Tasks, Architecture and QoS Provisioning”, published in Multimedia Tools and Applications, Kluwer Academic Publishers, Boston, US, Volume 16, Number 1-2, 1 Jan. 2002, pages 99 to 136, by R. Boutaba et al. A further evolution of such kind of broadcast system is disclosed in U.S. Pat. No. 9,462,195 B2. The data that need to be transmitted via the IP network include control data, video, audio, metadata, etc. For instance, the IP network is composed of a set of network switches, and a set of devices that communicate via the network switches. One example of such a network is shown in FIG. 1 and will be described in greater detail further below.

A broadcast production needs a network that is as reliable as the traditional SDI based networks. At any given moment, it must be certain that the network transmits the required video, audio and/or data streams with the correct latency, jitter, bandwidth, and other transmission parameters that have to be met for achieving

For that purpose, a controller is introduced, called broadcast controller to ensure that the network behaves properly. The broadcast controller leverages the so-called SDN (Software Defined Networks) technology. The broadcast controller will basically manage all the requests for communication between devices: It will look into the request and grant the request or not. If the request is granted, the broadcast controller configures all the switches in the network such that the request flow passes through the network with the required quality and without disturbing the already ongoing communications. If the request is not granted, the devices do not get the permission to communicate. In this way the network is configured to block traffic of rogue senders.

### SUMMARY

According to a first aspect the present disclosure suggests a broadcast production system including broadcast production devices and network switches which are connected with a network transmitting data streams. The system further includes a broadcast controller configured to manage communication between the different broadcast devices such as production servers, replay servers, video mixers, etc. and a processing device connected to at least one network switch. The processing device is configured to ingest a data stream passing through the at least one network switch.

The broadcast production system provides operational flexibility since it permits different ways of using the ingested data streams. E.g. the ingested data streams are stored in the buffer memory or a permanent memory that may be shared memory. Different applications tap into the buffer and or the shared memory. The applications can be started and stopped independently without interrupting each other or the continued ingest of the data streams into the processing device.

Advantageously, the processing device is connected with a reproduction device enabling a human operator to perceive the contents of the data stream ingested by the processing device. In a practical embodiment the reproduction device is a display for reproducing video streams and a loudspeaker for reproducing audio streams. The reproduction device can either be directly connected to the processing device or be connected to a separate processing device, in which case the former processing device sends a suited audio and/or video signal to the latter processing device.

In a useful embodiment the processing device is connected to a plurality of network switches and is configured to selectively and dynamically ingest a plurality of data streams passing through the plurality of network switches. This embodiment enables to selectively choose data streams that are ingested into the processing device. In this way the production director can focus on those data streams, which are at any given moment, the most important for the production.

In an advantageous embodiment the processing device or broadcast controller controls at least one of the network switches to replicate a data stream and to transfer it to the processing device. The replication of the data stream makes it available for the processing device without interrupting the transfer of the data stream to another broadcast production device, so without interrupting the ongoing broadcast production. The replication is effected by port replication of the network switch or by generating an additional branch in the multicast tree connecting the network switches with the processing device.

According to another embodiment the processing device or broadcast controller controls at least one switch in the system to switch between a first and a second input data stream (that is to generate a new or output data stream by switching from one stream to another) only after a complete data frame (for the purpose of illustration, this can be an image from a video stream) of a currently transmitted data stream (the first stream) has been received from the network switch, ensuring that the resulting output data stream is an uninterrupted flow of data frames (images for the sake of illustration) existing of complete data frames of the first stream, followed by complete data frames of the second stream. Advantageously, this embodiment of the broadcast production system implements a clean switch functionality which means that the network switches from one data stream to another at exactly the right moment, that is only if a complete data frame of the currently transmitted data stream has been received from the network switch and ensuring that this complete data frame of the first stream is followed by a complete data frame from the second data stream. In this way it is assured that the switching process does not generate corrupted data frames. Every single data frame is a valid and complete data frame that belongs either to the first input data stream or to the second input data stream.

Practical examples of this “clean switch” embodiment include, but are not limited to, a video clean switch, where an output video feed is generated from a consecutive sequence of complete images from a first input video feed, uninterruptedly followed by a consecutive sequence of complete images from a second input video feed. A second example includes the so-called audio shuffling, where audio channels of multiple incoming audio data feeds are mixed and matched to generate new outgoing audio feeds. A third example includes the “quiet switch” functionality for audio channels, where the processing device generates a continuous output audio stream, from a consecutive sequence of audio samples from a first input audio feed, uninterruptedly followed by a consecutive sequence of complete audio samples from a second input audio feed. The processing device integrates the necessary logic to ensure that this switch happens without audible artefacts. A fourth example is the so-called camera shader use case. The camera shader use case is an extension of the clean switch. Where a clean switch switches between two input data feeds, the camera shader application will switch between a plurality of input data feeds, typically in a round robin fashion. An important criterion for the camera shader is the speed of the switching. The implementation ensures an extremely high switch rate.

In a useful embodiment the processing device is configured to provide received data streams to applications. The applications process the replicated data streams to implement for example one or several of the following functionalities including clean switch, audio shuffling, quiet audio switch, colour correction, scaling, compression, network address translation, and reproduction for monitoring and visualisation (multiviewer) purposes. All these applications require the processing device to generate one or more output data streams, such as the output stream of a clean switch, or the output stream of an audio shuffling operation, or the output stream of a colour corrected data stream, or the information to be sent to a reproduction device. The broadcast controller and processing device control at least one network switch to further transmit these output data streams via the network.

According to a second aspect the present disclosure suggests a method for operating a broadcast production system. The broadcast production system comprises broadcast production devices and network switches being connected with a network transmitting data streams. A broadcast controller is configured to manage communication between the broadcast devices and a processing device connected to at least one network switch. The method comprising
sending the request to at least one network switch to replicate a data stream passing through the network switch;
transmitting the replicated data stream to the processing device; and
ingesting the replicated data stream at the processing device.
transmitting the output of the processing device through the network switches

The suggested method for operating a broadcast production system provides operational flexibility since it permits different ways of using the ingested data streams. E.g. the data streams ingested in the processing device are stored in the buffer memory or a permanent memory that may be a shared memory. Different applications tap into the buffer and or the shared memory. The applications can be started and stopped independently without interrupting each other or the continued ingest of the data streams into the processing device.

In accordance with an embodiment the method further comprises transmitting the replicated data stream to a reproduction device; and reproducing the replicated data stream on the reproduction device enabling a human operator to perceive the replicated data stream. In this way a production director can monitor the data streams and verify that the broadcast production system is properly working. The reproduction device can either be connected directly to the processing device, either be connected to a separate processing device, in which case the former processing device sends a suited audio and/or video signal to the latter processing device.

The processing devices offer maximal flexibility: a plurality of the before mentioned applications can be executed by the processing device on the ingested data streams to generate output data streams. Multiple processing devices can be used in the same broadcast production, allowing scaling the number of applications.

In an advantageous further development the method further comprises instructing multiple switches to replicate sequentially different data streams for a predetermined period of time; sending the replicated data streams to the processing device; and transmitting the replicated data streams to the reproduction device for reproduction. Sequential reproduction of short sequences of different video streams permits the production director to verify the contents of the plurality of video streams even when the number of reproduction resources is smaller than the number of videos streams to be monitored.

In a particularly advantageous embodiment the method further comprises comparing the replicated signal streams at the processing device to assess the quality of different data streams. If the data streams are received from different network switches at different locations within the network the comparison of the data streams provides valuable information of possible issues or impairments of the network link between the respective network switches. In a specific embodiment the quality assessment is performed by dedicated software executed by the processing device.

In yet another embodiment the method further comprises performing at least one of the following processes on the replicated signals streams
colour correction;
scaling;
compression for contribution purposes;
network address translation, in particular multicast network address translation;
multiviewer;
camera shader; and
audio shuffling.

These additional functionalities contribute to the flexibility of the broadcast production system.

### BRIEF DESCRIPTION OF DRAWINGS

Exemplary embodiments of the present disclosure are illustrated in the drawings and are explained in more detail in the following description. In the figures the same or similar elements are referenced with the same or similar reference signs. It shows:

FIG. 1 a topology of a network composed of switches and devices;

FIG. 2 examples of communication between the switches and devices of the network shown in FIG. 1;

FIG. 3 a broadcast controller configuring the switches in the network shown in FIG. 1 and granting access;

FIG. 4 a processing device is connected to all the switches in the network shown in FIG. 1;

FIG. 5 images corresponding to the video flows that are transmitted over the different IP links are shown in individual players;

FIG. 6 a schematic illustration how the broadcast controller instructs a switch to replicate the original video signal;

FIG. 7 a schematic illustration of the concept of a clean switch;

FIG. 8 a schematic illustration of a multiviewer; and

FIG. 9 a schematic block diagram of a processing device.

### DESCRIPTION OF EMBODIMENTS

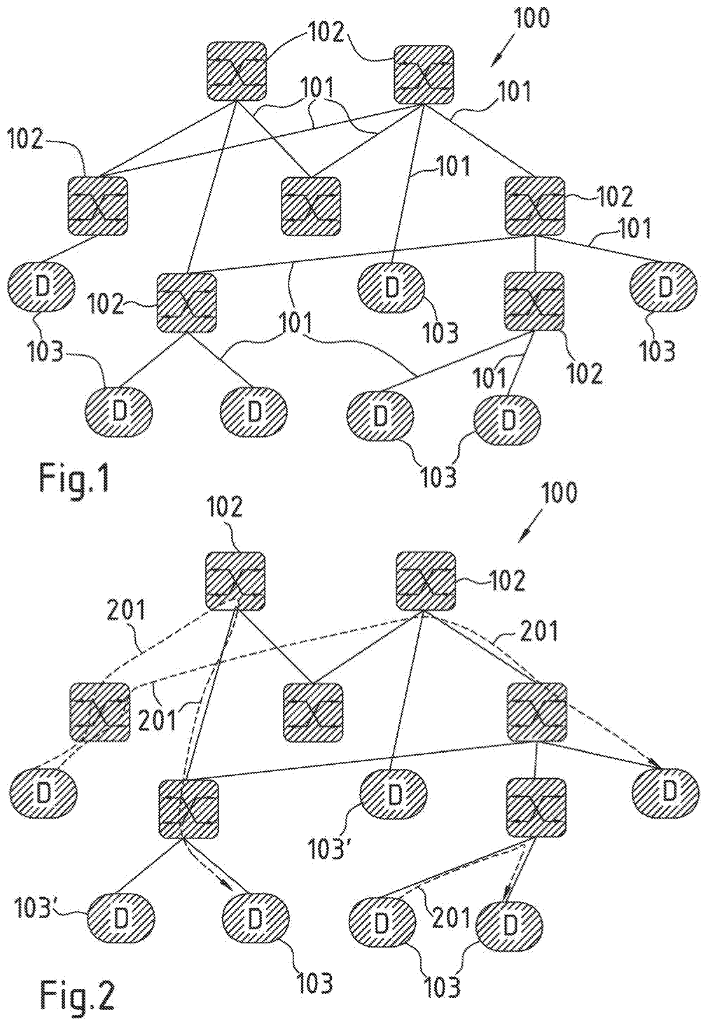

FIG. 1 shows a distributed broadcast production system 100 where all communication happens over an IP network symbolized by communication connections 101. The IP network is composed out of a set of network switches 102, and a set of broadcast production devices 103 that communicate via the network switches 102. In the following the network switches 102 are briefly referred to as switches 102. In this example broadcast production devices such as mixers, cameras, matte generators, graphical effect generators etc. are represented generally as “devices” because the emphasis in the context of the present disclosure is on the communication between the devices and not on the different functionalities performed by the devices. For the sake of completeness it is nevertheless noted that one of the devices outputs a program production stream which is broadcasted. The signals or signal streams communicated between the switches 102 and the devices 103 include control data, video, audio, metadata, and other signals. The devices 103 exchange information via the switches 102 as shown by dashed lines 201 in FIG. 2. As can be seen in FIG. 2 some devices 103 communicate while devices 103′ remain inactive even though they are connected with a communication connection 101.

The IP network is only one example of a network providing communication between the network switches and broadcast production devices. The present disclosure can be implemented also with other types of networks.

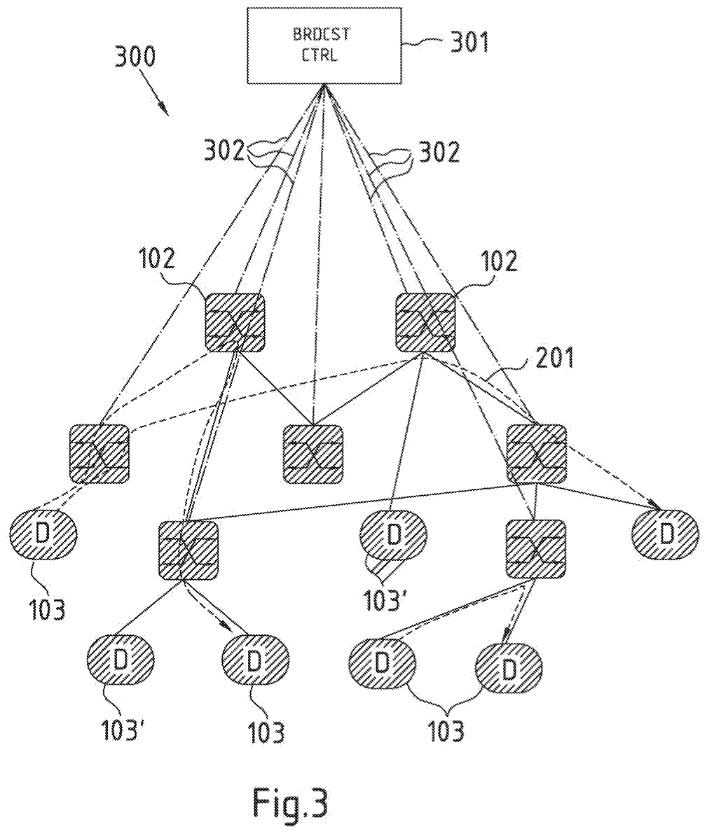

FIG. 3 exhibits a broadcast production system 300 which is evolved compared to the broadcast production system 100 shown in FIGS. 1 and 2 will because it includes additionally a broadcast controller 301, which ensures that that the IP network behaves in a controlled manner. I.e. the broadcast controller 301 basically manages all requests for communication between the devices 103: The broadcast controller 301 is connected with the switches 102 by connections 302. The broadcast controller 301 can communicate with the devices 103 via the connections 302 and 101. The broadcast controller 301 verifies each request and grants the request or not. If the request is granted, the broadcast controller 301 configures all the switches 102 in the network such that the data communication according to the request passes through the network with the required quality and without disturbing the already ongoing communications. If the request is not granted, the devices involved in the request do not get the permission to communicate. The network is configured to block traffic of rogue senders. Rogue senders send wrong and too much information into the network causing the network to fail because they prevent the good information to traverse the network. The broadcast controller leverages the so-called SDN (Software Defined Networks) technology.

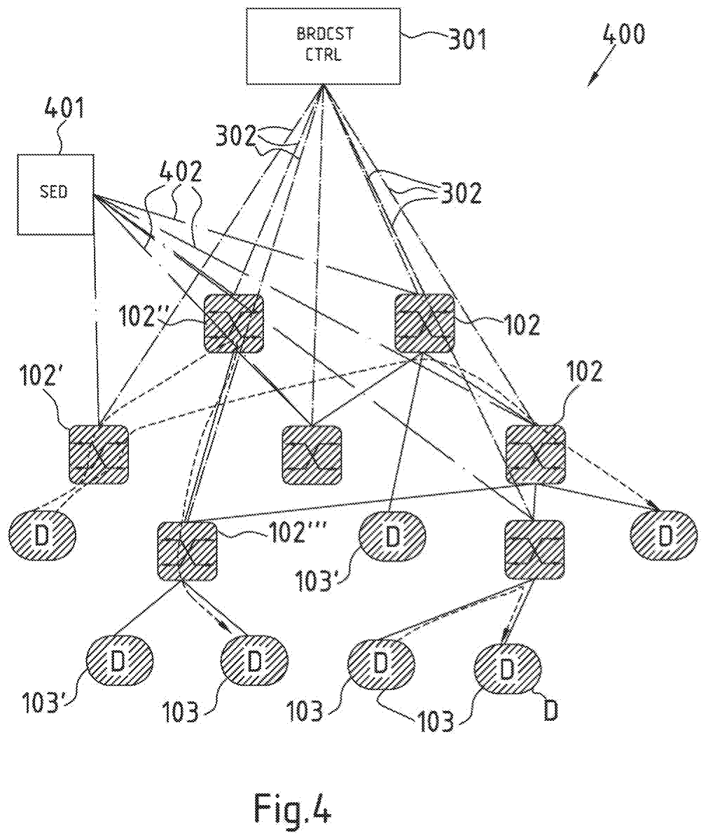

FIG. 4 shows another embodiment of distributed broadcast production system 400 which further includes a dedicated processing device 401. Apart from that the topology of the broadcast production system 400 is similar to the broadcast production system 300 displayed in FIG. 3. The processing device 401 is connected to each switch 102 either directly or indirectly by connections 402. For instance, the processing device 401 is directly connected with switch 102′. The processing device 401 is indirectly connected with switch 102′″ because the corresponding connection 402 passages at first through switch 102″. The connections 402 between the processing device 401 and the switches 102 are called edges 402.

In the following the functionality of the processing device 101 is described.

Monitoring/Virtual Heartbeat

Monitoring is very important in live productions. In SDI based production systems a physical wire equals an SDI video signal. In IP network based productions many video (and audio and data, and other) signals are multiplexed over the same physical network connection. The present disclosure aims at giving a broadcast production engineer or director the opportunity of having a feedback of the signals being carried over the network. A visual feedback of video streams or video signals is particularly important. For the sake of brevity the following description will focus on videos streams or video signals representative for other types of signals such as audio signals or data streams. In the case of audio signals the feedback will be presented as audible signal while for data streams other types of appropriate feedback signals can be chosen by design.

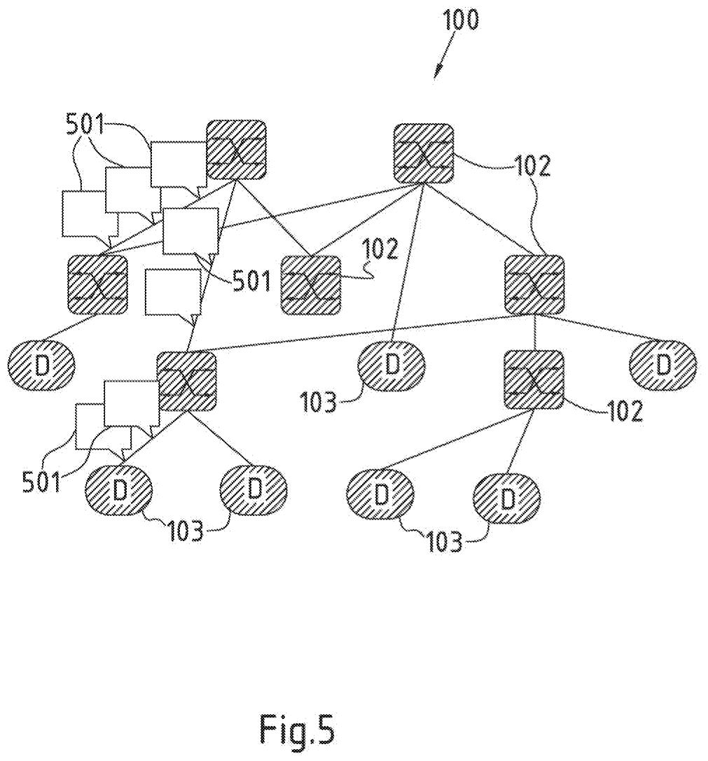

FIG. 5 schematically shows the concept of a possible implementation for providing visual feedback for different video streams which are transferred through the broadcast production system 100. Each frame 501 shown in FIG. 5 symbolizes images corresponding to the video streams that are transmitted over the different IP links. The frames 501 symbolized images or sequences of images of a visual feedback that is displayed on a monitor or display device. Likewise, the audio signals and the metadata and other signals can be represented by other appropriate reproduction devices.

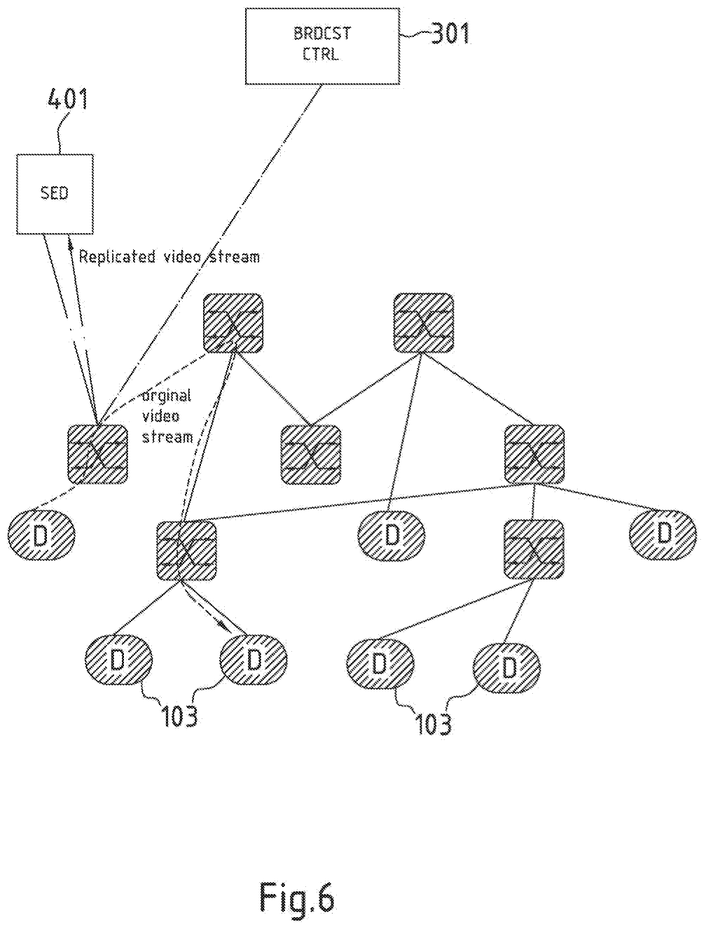

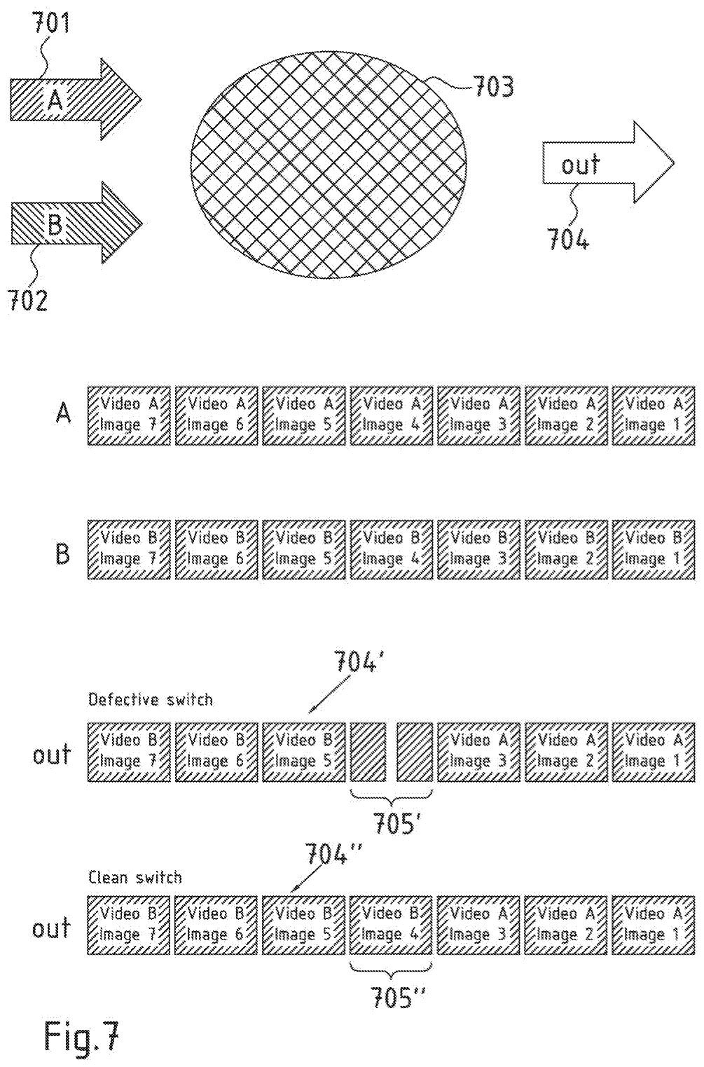

Technically, the images are generated by replicating the video stream processing device 401. In FIG. 6 it is illustrated how the broadcast controller instructs one switch 102 to replicate the original video signal over one of the edges 402 to the processing device 401. This replication is controlled by the broadcast controller 301 that instructs a given switch 102 to replicate the video stream via one edge 402 to the processing device 401. This replication is technically achieved either by port replication or by generating an additional branch in the multicast tree connecting the network switch with the processing device 401 because in a network based broadcast production system all data streams including video, audio and data streams are transmitted using multicast transfers. In the case of a port replication the complete content of the link that transferred the desired video stream is replicated. The processing device 401 extracts the desired video stream from the complete content.

Since several hundreds of video signals can be transferred over the network, it is not viable, within a realistic amount of processing resources, to display all signals concurrently. In accordance with the present disclosure this problem is solved by displaying intermittently an image of each video flow. That means that, if there are N video streams, and only one resource for displaying the video, that N video streams are intermittently displayed:

A few frames of video stream 1>>A few frames of video stream 2>> . . . >>A few frames of video stream N>>A few frames of video stream 1>>A few frames of video stream 2>> . . . >>A few frames of video stream N>>

In case we have M resources for displaying video, then N/M video streams are intermittently displayed:

On a first resource for displaying video the following sequence is displayed:

A few frames of video stream 1>>A few frames of video stream 2>> . . . >>A few frames of video stream N/M>>A few frames of video stream 1>>A few frames of video stream 2>> . . . >>A few frames of video stream N/M>>

On a second resource for displaying video the following sequence is displayed:

A few frames of video stream N/M+1>>A few frames of video stream N/M+2>> . . . >>A few frames of video stream N/M+N/M>>A few frames of video stream N/M+1>>A few frames of video stream N/M+2>> . . . >>A few frames of video stream N/M+N/M>> . . . .

This concept is applied for all M resources for displaying video.

In order to achieve sequentially displaying subsequent samples of each video stream, the broadcast controller 301 continuously sends instructions to the switches to replicate the subsequent video streams:

Time 1: broadcast controller instructs switch A to replicate stream 1 during x images.

Time 2: broadcast controller instructs switch B to replicate stream 2 during x images.

Time 3: broadcast controller instructs switch C to replicate stream 3 during x images.

Time 4: broadcast controller instructs switch D to replicate stream 4 during x images.

Each placeholder “switch A”, “switch B” etc. stand for one individual switch 102 in the broadcast production system 400.

It is the combination of the broadcast controller 301 controlling the video stream replication to the processing device 401 and the processing device 401 that ensures a decent visualization of all streams avoiding excessive expenditure of processing resources and hardware devices.

Technically, the processing device 401 receives the replicated video streams and displays these images with small latency on a screen. The signal handling within the processing device 401 that is capable of achieving the desired latency is explained in greater detail further below.

In an alternative implementation the processing device sends the images to a centralized user interface, e.g. a broadcast controller user interface, for centralized display of all different video streams. In that case, an advantageous implementation might transfer lower resolution images to facilitate centralized processing.

This kind of monitoring is sometimes also named as “virtual heartbeat”.

Monitoring/Virtual Patching

Monitoring of the virtual heartbeat type allows the production engineer or director validating that the video flows are still being transferred, and that the correct flows are sent. However, it is equally important that a single video stream or a single link can be monitored. Upon request, the broadcast controller 301 instructs a switch 102 either to replicate the video stream that needs to be transmitted or all data that is transferred over the link that must be monitored. To do so the mechanism of port replication is used which is available in modern switches. Whereas the Virtual Heartbeat mechanism will only shortly display the video, allowing having an overview of all the flows in the system, in the virtual patching mode the video is continuously displayed, allowing the broadcast engineer to validate the content. If needed, standard image quality metrics are applied. For this type of monitoring the term “Virtual Patching” because it refers to the common practice in SDI based networks of simply “patching” the physical SDI cameras to a monitor.

In a first mode, the Virtual Patching simply replicates the content from one switch for display via the processing device 401. Since video streams are exchanged over the network, and exchanged between switches, the Virtual Patching mode has a second mode of operation. Rather than only replicating the streams from one switch, the flows are replicated from two switches, i.e. the sending and the receiving switch. In this way, it is possible to not only monitor the flows will at a given switch, but also to monitor a possible degradation of the video stream transferred on the link between two switches, in particular, if standard image quality metrics are applied. The Virtual Patching mode is feasible because on the level of the broadcast controller 301 the two ends of each connection are known. This enables the broadcast controller 301 to instruct the respective switches accordingly.

Contribution BreakOut, Colour Conversion

Since the processing device 401 is capable of receiving any video stream transmitted in the broadcast production system, the processing device 401 can be used to perform additional conversions on video streams. These additional operations include colour correction, scaling, compression for contribution purposes, and others.

The tools for performing this kind of operations are known to a person skilled in the art. However, the present disclosure suggests an advantageous implementation for these operations.

Clean Switch

The processing device 401 can also implement a clean switch. A clean switch is a notion from the broadcast industry implying that a video flow A is replaced by a video flow B without artefacts. This problematic situation when a video stream A is simply cut in the middle of an image or frame is illustrated in FIG. 7. Video streams A and B labelled with 701 and 702, respectively, are received by a device 703 that outputs a single video stream 704 which is either video stream A or video stream B. The videos streams are schematically illustrated in the lower part of FIG. 7. In the example shown, the output video stream 704′ initially consists of video images of the video stream A. After video image 3 of the video stream A, a switch to the video stream B occurs while video image 4 of video stream A is still in the process of being transmitted. Transmission of video image 4 of video stream B interferes with the transmission of video image 4 of video stream A. This is symbolized in FIG. 7 with a “broken” image at position 705′ in the output video stream 704′.

The present disclosure suggests an improvement in this regard by implementing the concept of a clean switch. I.e. a new image of video stream B is only served after the end of a currently transmitted image of videos streams A has been received.

According to the concept of the clean switch video streams A and B are sent through the network across the connections 101. At some point a switch from the video stream A to the video stream B is required. Without provision, some image of a video output stream (out) will be cut in pieces, resulting in at least one bad image containing artefacts introduced by the switching. A clean switch will look where an image of flow A stops, and where one image of flow B starts. It will then cut the streams at that location between data packages of the stream, taking jitter into account.

More specifically, the processing device 401 receives a video stream A. Upon a user request for a clean switch, the processing device 401 also receives a video stream B. This is managed by the broadcast controller 301 that instructs the appropriate switch 102 to send the required video stream B to the processing device 401. The processing device 401 allows the packets of the video stream A to continue until an “EndofImage” flag is encountered. The “EndofImage” flag indicates that all packages of a currently transmitted video frame have been transmitted. At that moment no further packets of video stream A are transmitted. Instead, packages of video screen B are transmitted starting when a “StartofImage” flag of the video stream B is received. The “StartofImage” flag indicates the first package of video frame that is to be transmitted. The processing device 401 copes for jitter and other network impairments that can happen, to ensure a clean output, i.e. a clean switch between videos streams A and B. The concept of a clean switch is illustrated in FIG. 7 in the output video stream 704″. The switching occurs exactly after image 3 of video stream A has completely been received and before reception of image 4 of video stream B begins. In consequence, the video image at position 705″ is a complete and correct image, namely image 4 of the video stream B.

Multicast Network Address Translation (NAT)

Processing device 401 equally implements multicast NAT. As mentioned above, video, audio and data streams in a network based broadcast production system are sent using multicasts. That means that the different receivers in the network need to listen to a specific multicast address that corresponds to the video stream they want to receive. Older or static receivers do not have the flexibility to listen to different addresses. These older receivers always listen to the same multicast address, regardless the fact that the video comes from different sources. In order to cope with this issue, the processing device 401 will translate the address of any incoming video into the specific address to which the receiver is listening.

Multiviewer

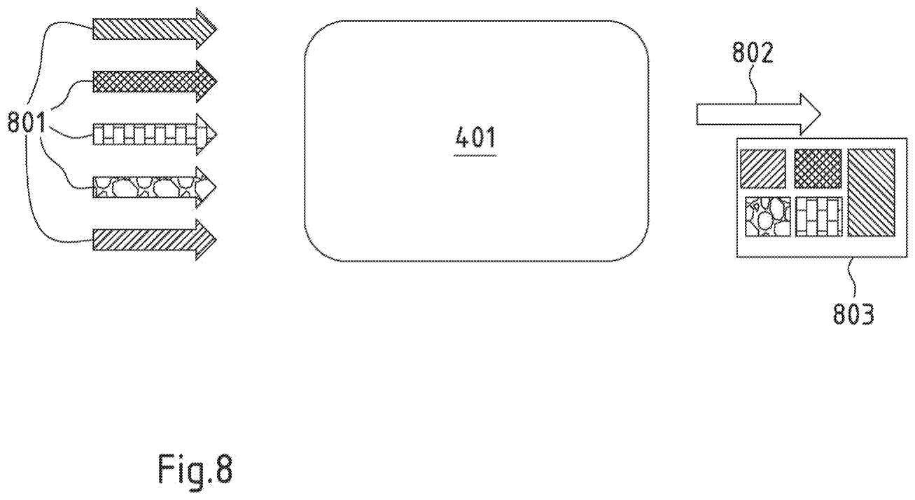

Processing device 401 equally implements a multiviewer. The multiviewer functionality is an extension of the monitoring functionality, by allowing not a simple reproduction of a data feed, but the reproduction of multiple data feeds. As shown in FIG. 8, the multiviewer will combine a plurality of input feeds 801 into a combined output feed 802, which is displayed on a monitor 803.

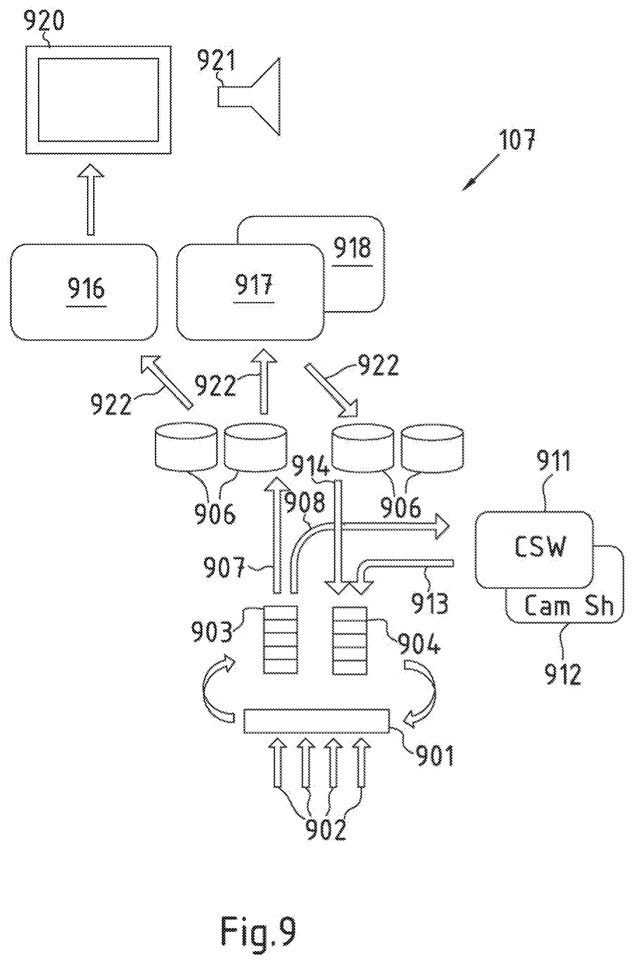

The advantageous implementation that will be described in greater detail in connection with FIG. 9 allows for a minimal latency transfer, which is a critical design criterion for multiviewers.

FIG. 9 shows a simplified block diagram of a processing device 107. A network card 901 is connected with the network being part of the broadcast production system and receives a plurality of video and/or audio streams which are symbolized by arrows 802. The network card 901 is part of the processing device, and implemented either in dedicated hardware or using a COTS NIC. The processing device 107 comprises a buffer 903 for the received data packets and a buffer 904 for data packets which are to be transmitted into the network. The processing device 107 includes a shared memory. In one embodiment the shared memory 906 is realized by RAM memory. The RAM memory is either integrated into the processing device 107 or external to it. In either case received data packets can be transferred to the shared memory and stored in the shared memory as it is symbolized by arrow 907. Alternatively, the received data packets are directly transferred to applications. The transfer of the data is symbolically indicated by arrow 908. One example of an application is a clean switch functionality 911 described above that operates with the same latency associated with individual data packets. I.e. the clean switch functionality is capable of switching between individual packets and avoids in this way any latency. Another possible application is a camera shader application 912 that needs to be able to switch cleanly between a large number of input data feeds at very high speeds. These two applications are only examples. The present disclosure is not limited to a particular application. The essential point rather is that the architecture of the processing device 401 is designed such that the different applications can be started and stopped dynamically without interrupting the ingest of video, audio and/or data streams into the processing device 107 and without interrupting concurrently executed applications.

The output of applications such as application 911 and 912 is transferred back to the buffer 904 as indicated by arrow 913. Likewise data can be read out from the shared memory 906 and transferred to the buffer 904 as it is illustrated by arrows 914.

Other applications labelled as 916, 917, and 918 communicate data with the shared memory 906. The shared memory is extremely flexible, allowing being accessed both on an image basis (images are fetched on an image per image basis) or on a sub-part of an image basis (images are e.g. fetched line per line, or block per block). This flexible access method allows different applications that have different requirements in terms of processing and system latency to share the same memory pool, hence avoiding unnecessary copies of the same input feed for different applications.

Application 916 for example monitors streams that have been stored in the shared memory 906. The monitoring application fetches the images on a per-image basis from the shared memory. This allows for a simple application design for the video display. The monitored video stream is sent to a reproduction device such as a display 920 or a loudspeaker 921. The transmission of the data is indicated as arrow 919.

Application 917 for example is a multi-viewer application generating an output stream that contains a plurality of video streams that can be displayed simultaneously. Since the multi-viewer application is extremely sensitive to latency, this application makes use of the feature to access the shared memory on a line per line basis, hence reducing the system latency to the bare minimum (but at the expense of more complex processing).

Application 918 is a colour correction application that processes stored video streams to correct colours and restores the colour corrected video streams. The communication between the shared memory 906 and the applications 916, 917, and 918 are indicated by arrows 922.

Technical Implementation

The Processing Device is implemented as a flexible pipeline consisting of
Ingest functionality: to receive the replicated flows
packet operators
clean switch
color shader
Image operators
   Scalers
   Compression
Output functionality
   to display (eg for monitoring)
   to the network, eg for the clean switch output, or the breakout to contribution, or . . .

| | | | Image conversions | | | | | |
|---|---|---|---|---|---|---|---|---|
| | | Audio | such as scalers, | | Image | | | |
| | | sample | colour conversion, | | block | packet | Output to | Output to |
| | Ingest | operation | . . . | Compression | manipulation | manipulation | display | network |
| Heartbeat | ✓ | | | | | | ✓ | |
| Heartbeat to | ✓ | | | (✓) | | | | ✓ |
| centralized | | | | | | | | |
| UI | | | | | | | | |
| Virtual | ✓ | ✓ | | | | | ✓ | |
| patching | | | | | | | | |
| Contribution | ✓ | | | ✓ | | | | ✓ |
| breakout | | | | | | | | |
| Image | ✓ | | ✓ | | | | | ✓ |
| conversion | | | | | | | | |
| Clean switch | ✓ | | | | | ✓ | | ✓ |
| & camera | | | | | | | | |
| shader | | | | | | | | |
| Audio shuffle | ✓ | ✓ | | | | | | ✓ |
| Multicast | ✓ | | | | | ✓ | | ✓ |
| NAT | | | | | | | | |
| multiviewer | ✓ | ✓ | | | ✓ | | | ✓ |

Clearly, this pipeline is implemented in an optimized way, ensuring the lowest possible latency, while still being resilient to network impairments such as jitter.

A possible implementation of the Processing Device is a complete software implementation. This allows for virtualization. A scalable set of hardware servers can be deployed, on which the software is executed on an as-needed basis. This scalability allows the Processing Device to scale easily in function of requirements, number of flows and number of switches in the network.

Being software based, the Processing Device can also be collocated with the Broadcast Controller itself.

At every place in this text where reference is made to “video flows”, “video”, “video streams”, actually any flow or stream is meant (audio, video, metadata, . . . ) that is exchanged over the IP network during an IP based broadcast production.

Reference herein to “one embodiment” or “an embodiment” means that a particular feature, structure, or characteristic described in connection with the embodiment can be included in at least one implementation of the disclosure. The appearances of the phrase “in one embodiment” in various places in the specification are not necessarily all referring to the same embodiment, nor are separate or alternative embodiments necessarily mutually exclusive of other embodiments.

While the disclosure may be susceptible to various modifications and alternative forms, specific embodiments have been shown by way of example in the drawings and will be described in detail herein. However, it should be understood that the disclosure is not intended to be limited to the particular forms disclosed.

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described below comprise separate devices to facilitate the understanding of different functional group of the present disclosure. However, it is to be understood that some devices may very well integrated in a single device.

1. Broadcast production system including broadcast production devices and network switches being connected with a network transmitting data streams, further including a broadcast controller configured to manage communication between the broadcast devices and a processing device connected to at least one network switch, wherein at least one network switch is configured to replicate a data stream passing through the network switch, wherein the processing device is connected with the at least one network switch to receive and ingest the replicated data stream, wherein the processing device is configured to provide received data streams to applications without interrupting the ingest of data streams, and wherein the applications generate output data streams.

2. Broadcast production system according to claim 1, wherein the processing device is connected with a reproduction device enabling a human operator to perceive the contents of the data stream ingested by the processing device.

3. Broadcast production system according to claim 1 or 2, wherein the processing device is connected to a plurality of network switches and is configured to dynamically and selectively connect with all or a subset of network switches off of the plurality of network switches to ingest data streams passing through the plurality of network switches.

4. (canceled)

5. Broadcast production system according to claim 1, wherein the processing device controls at least one network switch in the system to switch between a first and a second input data stream only after a complete data frame of a currently transmitted data stream has been received by the network switch.

6. (canceled)

7. Method for operating a broadcast production system, wherein the broadcast production system comprises broadcast production devices and network switches being connected with a network transmitting data streams, and a broadcast controller configured to manage communication between the broadcast devices and a processing device connected to at least one network switch, the method comprising
sending the request to at least one network switch to replicate a data stream passing through the network switch;
transmitting the replicated data stream to the processing device;
ingesting the replicated data stream at the processing device; and
transmitting the output data feeds generated by the application through the network switches.

8. Method according to claim 7, further comprising
transmitting the replicated data stream to a reproduction device; and
reproducing the replicated data stream on the reproduction device enabling a human operator to perceive the replicated data stream,
the reproduction device can be connected directly to the processing device, or can be separate from the processing device, in another location of the network, in which case the output of the processing device needs to be transmitted over the network to the reproduction device

9. Method according to claim 7, wherein the method further comprises
instructing multiple switches to replicate sequentially different data streams for a predetermined period of time;
sending the replicated data streams to the processing device; and
transmitting the replicated data streams to the reproduction device for reproduction.

10. Method according to claim 9, further comprising
comparing the replicated signal streams at the processing device to assess the quality of different data streams.

11. Method according to claim 7, further comprising performing at least one of the following processes on the replicated signals streams
colour correction;
scaling;
compression for contribution purposes and/or
network address translation, in particular multicast network address translation;
multiviewer;
camera shader; and
audio shuffling.

12. Method according to claim 9, further comprising
instructing multiple switches to transfer the output data streams of the processing device.
